(19) United States
(12) Patent Application Publication
(10) Pub. No.: US 2012/0136836 A1
(43) Pub. Date: May 31, 2012

(54) Cloud Storage Data Storing and Retrieving Method, Apparatus and System

(75) Inventor: Hui Liu, Beijing (CN)

(73) Assignee: Beijing Z & W Technology Consulting Co., Ltd., Haidian District, Beijing (CN)

(21) Appl. No.: 12/999,261

(22) PCT Filed: Dec. 1, 2010
(86) PCT No.: PCT/CN10/79321

§ 371 Date: Dec. 15, 2010

(30) Foreign Application Priority Data
Nov. 29, 2010 (CN) 201010563718.3

(51) Int. Cl. G06F 17/30

(52) U.S. Cl. 707/679; 707/737; 707/E17.089; 707/E17.007

(57) ABSTRACT

The present application relates to cloud storage technology and especially relates to a cloud storage data store and retrieval method, apparatus and system. The data storing method comprise grouping source data to be stored according to a predetermined grouping rule; reorganizing the content of the grouped source data to form new data; transmitting the new data to a cloud storage data center for storage. The data retrieval method comprises, as requested, retrieving the data from a cloud storage data center; acquiring data recovery information corresponding to the data; restoring the data to source data according to the data recovery information. This application also provides a cloud storage data storing and retrieving apparatus and system. This invention can improve the data security of cloud storage and mitigate the risk of user data illegal leak and decryption.

### TECHNICAL FIELD

The invention relates to cloud storage security technology and especially relates to a cloud storage data storing and retrieving method, apparatus and system.

### BACKGROUND OF THE INVENTION

Data has been proven to be an important asset of enterprises, and the rapid growth of data is bringing unprecedented challenges to enterprises. Meanwhile, the cost pressure brought by the fast changing world economic situation and fierce competition have compelled the enterprises to consider how to reduce IT costs and address the ever-growing storage demands of the enterprises.

The existing storage framework can be divided into two types, one is exclusive owned by one party, such as DAS (direct attached storage), SAN (Storage Area Network) and NAS (Network access server), etc. This kind of storage system is exclusively used by one party and can provide users with good control, better reliability and performance, however its expansibility is not good and is not suitable for large-scale deployment; moreover, it's not easy for users make use of their budget flexibly to address storage requirement (one-time investment is needed to buy storage equipments); and with the increase of the storage capacity demand, cost control will also face challenges.

The other is multi-party shared structure, namely the cloud storage framework, which, according to different service scopes, is divided into private cloud and public cloud. The cloud storage system is based on network technology (internet and intranet) and provides users with storage space for on-demand purchase, lease and on-demand allocation service. This service usually includes storage apparatus and professional maintenance personnel provided by a third party (or a department third party within enterprise). Through the storage service, enterprises (or departments within enterprise) can significantly reduce the demand for internal storage and the corresponding management cost so as to balance a soaring storage demand and enterprise cost pressure. Users of cloud storage could be individuals, enterprises, or even departments or branches within an enterprise.

However, for both operating modes of the cloud storage (private cloud and public cloud), data owners would inevitably concern over the data security and privacy, especially for public cloud storage users any of whose critical business data leak may cause inestimable losses.

Existing solutions are to encrypt the data before transferring it to a cloud storage data center. Therefore, the security of the data stored in the cloud storage data centers totally depends on the strength of encryption algorithm.

However, in cryptography, no encryption method except the “one-time pad” method has been mathematically proved unbreakable as stated in pages 6 and 12 of Applied Cryptography published by China Machine Press on Mar. 1, 2003. One-time pad still has some problems to solve to apply in cloud storage domain, typically large number of real random cryptographic keys generation, huge physical space to occupy for saving these random keys (this method requires that the length of random cryptographic key be at least equal to that of the plaintext), etc. Therefore none of the current data encryption methods already applied in cloud storage data security protection is a “one-time pad” encryption method.

But on the other hand, as decryption technology develops continuously, hardware price declines and performance rises drastically, the security of encryption algorithm will become increasingly unsafe. In addition, in order to ensure data encryption and decryption speed, the existing encryption algorithm used in cloud storage data protection usually is not the most complicated. This further aggravates users' concern over the reliability of cryptographic algorithm. Moreover, once users' data is encrypted and stored in a cloud storage data center via certain encryption algorithm, it is difficult to change the encryption algorithm to adapt to actual situation (e.g., the encryption algorithm being used is cracked).

It is noted that, under existing methodology, the content of files or partial files stored in a cloud storage data center are generally continuous. It can be imagined that once an enterprise's critical business data is decrypted, the loss is inestimable.

Given all the above, it is necessary to come up with a new method to improve data security protection for cloud storage and to make data difficult to be readable and usable even after it has been illegally acquired and decrypted, therefore mitigating risk of user data loss.

### SUMMARY OF THE INVENTION

The purpose of the present application is to provide a cloud storage data storing and retrieving method, apparatus and system so as to improve the security of the data saved in cloud storage data centers and reduce users' losses caused by data leak.

This present application provides a cloud storage data storage method comprising:

grouping source data to be stored according to a predetermined grouping rule;

reorganizing the content of the grouped source data to form new data; and

transmitting the new data to a cloud storage data center for storage.

This application provides a cloud storage data storage apparatus comprising:

a data grouping module for grouping source data to be stored according to a predetermined grouping rule;

a data reorganization module for reorganizing the content of the source data grouped by the data grouping module to form new data; and

a data transmission module for transmitting the new data formed by the said data reorganization module to a cloud storage data center for storage.

This application provides a cloud storage data retrieving method comprising:

retrieving data from a cloud storage data center according to a data access request;

retrieving data recovery information corresponding to the accessed data; and

restoring the accessed data to source data according to the data recovery information.

This application provides a cloud storage data retrieving apparatus comprising:

a recovery information acquisition module for acquiring data recovery information of accessed data according to a data access request;

a data retrieval module for retrieving the accessed data from a cloud storage data center according to the data recovery information acquired by the recovery information acquisition module; and

a data recovery module for restoring the accessed data retrieved by the data retrieval module according to the data recovery information acquired by the recovery information acquisition module.

This application also provides a cloud storage data storage and retrieval system comprising a data storage apparatus, a data retrieval apparatus and a cloud storage data center.

The data storage apparatus comprises:

a data grouping module for grouping source data to be stored according to a predetermined grouping rule;

a data reorganization module for reorganizing the content of the source data grouped by the data grouping module to form new data; and

a data transmission module, used to transmit the new data formed by the said data reorganization module to cloud storage data center for storage.

The data retrieval apparatus comprises:

a recovery information acquisition module for acquiring data recovery information of the data to be accessed according to a access request;

a data retrieval module for retrieving the accessed data from a cloud storage data center according to the data recovery information acquired by the recovery information acquisition module; and

a data recovery module for restoring the accessed data retrieved by the data retrieval module according to the data recovery information acquired by the recovery information acquisition module.

By grouping the source data to be stored according to a predetermined rule and transmitting the new data formed after the content reorganization of the grouped source data to a cloud storage data center, this invention improves the security of the data stored in the cloud storage data center and mitigates the risk of user data leak

### BRIEF DESCRIPTION OF THE DRAWINGS

FIG. 1 is a flow diagram of the cloud storage data storing and retrieving method according to an embodiment of the present invention.

FIG. 2 is a schematic diagram of a content sequence reorganizing method according to an embodiment of the present invention.

FIG. 3 is a schematic diagram of a content random reorganizing method according to the embodiment of the invention;

FIG. 4 is a flow diagram of a cloud storage data retrieval method according to an embodiment of the invention;

FIG. 5 is a structural diagram of cloud storage data storage apparatus according to an embodiment of the invention;

FIG. 6 is a structural diagram of a data reorganization module provided according to an embodiment of the invention;

FIG. 7 is a structural diagram of a cloud storage data retrieval apparatus according to an embodiment of the invention;

FIG. 8 is a structural diagram of a cloud storage data storage and retrieval system according to the embodiment of the invention.

### DETAILED DESCRIPTION OF THE PRESENTLY PREFERRED EMBODIMENTS

The following preferred embodiments are provided for further illustrating, but not for limiting, the present invention. The purpose of the embodiment of this invention is to group source data to be stored according to a predetermined rule and transmit new data formed after the content reorganization of the grouped source data in groups to a cloud storage data center.

As shown in FIG. 1, in accordance with an the embodiment of this invention, a cloud storage data storage method comprises:

Step S101, grouping the source data to be stored according to predetermined grouping policy.

In this embodiment, the grouping policy of the source data can be conducted by the number of the source data or the inter-relationship among source data;

Step S102, reorganizing the content of the grouped source data to form new data.

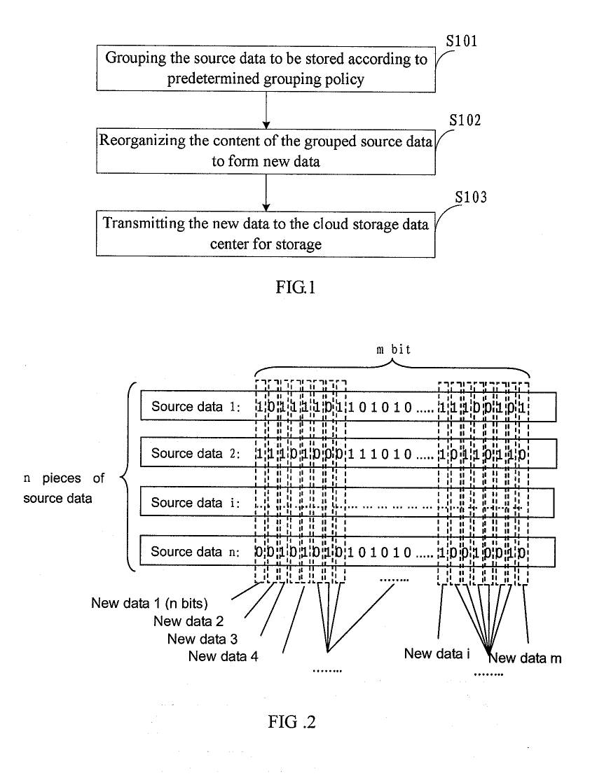

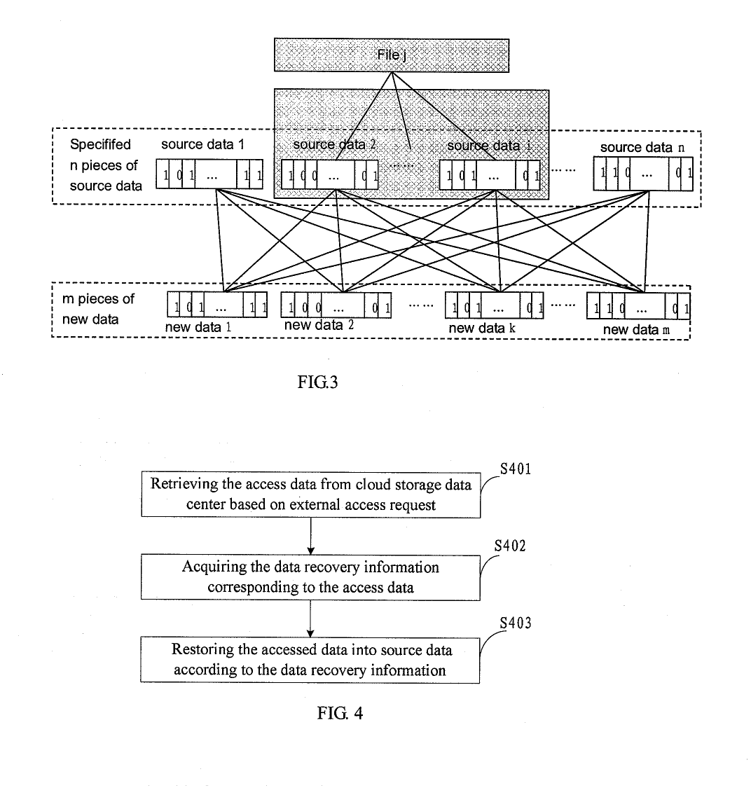

In this embodiment, content sequencing reorganization method or random reorganization method may be adopted to reorganize the content of the grouped source data; the said sequencing reorganization method is to, according to the predetermined fixed data sequencing rules, acquire data at the same location across each group and combine the acquired data according in sequence to form new data; random reorganization method is to, according to the predetermined data reorganization rules, traverse the corresponding source data that is to form new data, and then acquire data randomly from the source data according to the predetermined data acquisition rules, finally combine the acquired data according to sequence and form new data, see FIG. 3. Fixed sequencing rules may be but is not limited to be data bit ascending (see FIG. 2) or descending, odd number bit ascending or descending or even number bit ascending or descending, etc.

Step S103, transmitting the new data to the cloud storage data center for storage.

In this embodiment, after reorganizing the content of the source data to form new data according to step S102, it's required to output and save the data recovery information of corresponding relationship between the said source data and new data, which can be used to restore the retrieved data to source data.

As shown in FIG. 2, the content of the grouped source data is reorganized by vertically reorganizing the grouped and sorted specified n-line m-bit source data (each bit is 0 or 1, because the file is physically represented with a chain of 0 or 1) to form m-line n-bit new data.

In practical application, users may split the file to be stored into many source data, then divide these source data into many groups, and reorganize each group source data vertically into a group of new data.

When a sequence reorganization method is used, the corresponding relationship between the source data and the new data is relatively obvious. Therefore, it is relatively simple to restore the new data into source data, i.e. the source data is restored after all the new data is sorted according to a specified data sequence, and the new data in sequence is horizontally cascaded.

To further illustrate the feasibility of this invention, the difficulty to restore the reorganized new data to source data is analyzed as follows.

Assuming that each source data is a file or partial file, after vertically reorganizing the source data into new data, its content is in total confusion. Without leaking the corresponding relationship between the new data and source data, as all the new data is arranged in equal probability, there is no way to find which permutations and combinations are the real content of the original text, even the reorganized new data is illegally acquired from a cloud storage data center or during the transmission and successfully decrypted (assuming each n-bit new data needs to be processed by encryption or the like before transmitted to a predetermined cloud storage data center), the leaked data is very difficult to be readable and usable. Therefore, this method can strengthen the data protection in the event that the encryption algorithm is breakable and effectively mitigate the risk of user data loss.

Under data sequencing organization methodology, because only the sort orders of the new data and sourced data in each group need to be saved for data restoring, the amount of physical space occupied by the information concerning data sequence is very small and can be ignored, in comparison with that of the source data.

In this embodiment, a data random reorganization method may also be used to reorganize the grouped source data.

When reorganizing the data, all the data to be stored are firstly grouped according to a predetermined rule; in practice, source data may be grouped according to its number or relevance.

Secondly, the content of data is reorganized randomly according to a predetermined reorganization rule, including each new data corresponding to how many source data, data acquisition times and length, etc. The implementation method is shown in FIG. 3 and explained as follows.

Assuming file j is split into a chain of from source data 2 to source data i, these source data has been grouped together with data blocks from other files to form a group of source data for content reorganization.

If n pieces of f-bit source data of determined group is reorganized to m pieces of g-bit new data, each new data corresponds to p pieces of source data (1≦p≦n, larger p will affect the performance, while smaller will affect the security), each source data corresponds to r new data (1≦r≦m). In the process of constructing new data, data from each source data is acquired u times, each time for v bits (1≦v≦f).

Source data i is set as sdᵢ, new data k as tdₖ. Here m, n, p, r, i, k are natural numbers, u and v are integers greater than or equal to 0; p, u and v are true random numbers.

Details of content reorganization are shown as follows.

When constructing the new data k (tdₖ), its corresponding p source data is firstly traversed, data is acquired from each source data u times, each time for v bits. The data acquired from the source data i at the time q(1≦q≦u) for the new data k is identified as Ext_{iq}^{k} (s_{iq},e_{iq}), here s_{iq} is the starting cursor position randomly generated for data acquisition, e_{iq} is the ending cursor position randomly generated for data acquisition. s_{iq} and e_{iq} are natural numbers, and s_{iq}≦e_{iq}. If s_{q}=e_{iq}, it means that the bits number of this time acquired data is 0 bit, obviously, v=e_{iq}−s_{iq}+1. Cascade the acquired data together in sequence to create the new data to construct, which is represented as,

tdₖ=(Ext₁₁^{k}(s₁₁,e₁₁), Ext₁₂^{k}(s₁₂,e₁₂), . . . , Extₚᵤ^{k}(sₚᵤ,eₚᵤ))

After each data acquisition, the correspondence relationship between source data and new data is synchronously generated. Assuming v-bit data is acquired from sdᵢ at the time q, namely Ext_{iq}^{k} (s_{iq},e_{iq}), and placed at the corresponding position in tdₖ (can be figured out when place the acquired data into tdₖ), identifying this v-bit data acquired from sdᵢ corresponds to the data bit in tdₖ as Rxt_{kq}ⁱ(s_{kq},e_{kq}), wherein s_{kq} is the starting cursor position of this acquired data in tdₖ, e_{iq} is the ending cursor position of this acquired data in tdₖ. s_{kq} and e_{kq} are natural numbers, and s_{kq}≦e_{kq}. If s_{kq}=e_{kq}, it means that the bits number of the acquired data is 0 bit at this time. Furthermore, the source data sdᵢ can be constructed from new data by acquiring the specified data bits of its corresponding new data, namely

sdᵢ=(Rxt₁₁ⁱ(s₁₁,e₁₁),Rxt₁₂ⁱ(s₁₂,e₁₂), . . . , Rxtᵣᵤⁱ(sᵣᵤ,eᵣᵤ))

Similarly, in constructing the (k+1)th new data, the source data corresponding to the (k+1)th new data is traversed and data is acquired using the above method. The data acquired should not repeat with the previous acquired ones, namely, acquired data from the source data should not be repeated. Similar methods are used to generate all new data and save all the corresponding relationship between all the source data and generated new data.

In the above, each source data and reorganized new data may be of fixed length or not, and p, u, v may be variables, which means, they may be different at each data construction.

For the generation method of real random numbers p, u and v, there are already some existing methods available in page 301 of Applied Cryptography published by China Machine Press on Mar. 1, 2003, such as using random noise, computer clock, CPU load or network packets reaching number, etc., to generate the desired true random numbers.

Assuming three random numbers R1, R2, R3 has been generated by a certain real random number generation method, then

p=R1 mod n

u=R2 mod w

v=R3 mod f′

Here, mod is the modulo operation, w is the specified maximum value of determined u, f′ is the number of the remaining non-acquired bits in source data.

To further illustrate the feasibility and effectiveness of this reorganization method, the difficulty to restore the reorganized new data into source data is analyzed as follows.

As mentioned above, the whole data reorganization process is random (because p, u and v are real random number), and each bit of each source data content (in fact, 0 or 1) is equal in probability, so it's impossible to find any reversible method to restore the source data.

To prove this, the following will compare content random reorganization and the one-time pad encryption method, which has been mathematically proved to be unbreakable, regardless of infinite computational resources of the computer.

The one-time pad encryption method requires the cryptographic key must be true random numbers and used only once; the length of cryptographic key should be at least equal to that of plaintext; the plaintext is of equal probability; the cryptographic function can be as simple as XOR or the like.

To prove that, set f=g (if f≠g, just need to append enough 0 bits to make them with same length), because acquired data should not repeat during data reorganization, m=n. Since the source data and new data are of the same length and number, conduct XOR operation on the corresponding two data in a group, and identify the operation result as Zᵢ (the number of bits also is f, the same with that of the source data),

Zᵢ=sdᵢ⊕tdᵢ(i≦m,n)

According to XOR commutative law, tdi=sdi⊕Zi

Further, the method to generate new data each time can be converted to the XOR operation result between their corresponding source data and Zᵢ, which is to say, the restore process from tdᵢ to sdᵢ is equal to the process to obtain Zᵢ in effect. Because Zᵢ can be obtained from the XOR operation between sdᵢ and tdᵢ, the problem is converted to how many possible tdᵢ correspond to a determined sdᵢ (though tdᵢ is not necessarily acquired from sdᵢ).

Since each time there are f′−v methods to acquire data from the source data (f′ is the number of the remaining non-acquired bits in source data), and each new data is made up of the data acquired from its corresponding p source data for u times, so corresponding to the content of any tdᵢ, there are [(f′−v)^{u}]^{p} kinds of possibilities. In other words, every time when data is restored, Zᵢ has [(f′−v)^{u}]^{p} kinds of possibilities. It can be proved that when f′>2, v≦f−2, then [(f′−v)^{u}]^{p}>2^{u*p}, if set u=30, p=30, then Zᵢ will have a repetition probability of no more than ½⁹⁰⁰=1/(8.5*10²⁷⁰).

Meanwhile, as p, u and v are true random numbers, the randomness of tdᵢ can be guaranteed, and on the other hand, Zᵢ is calculated out from tdᵢ and sdᵢ, therefore it is not repeatable. Through the above analysis, it is arguable that Zᵢ is a non-repeatable random string of 0.1 values, analogy to true random cryptographic key in one-time pad encryption method. In addition, users may obtain a lower rate of recurrence of Zᵢ by adjusting the values of u and p to meet the requirement of higher randomness.

From the above analysis, it can be seen that for the high randomness of Zᵢ, the new data and source data are equal in length and the contents of new data and source data (plaintext) are equal in probability. The data content reorganization method in this invention has equivalent protection strength with the one-time pad encryption method, which is unbreakable.

In practice, cryptanalysts can hardly figure out how the data they have acquired is grouped, and whether the source data and new data are equal in length, etc., so, through content reorganization, the difficulty to restore the new data into source data will be greater than what has been proven above, thus the design objective of this invention is achieved, i.e. through data content reorganization, data can still be protected even if they are illegally decrypted.

Furthermore, the feasibility of this invention also depends on the size of physical space occupied by the correspondence relationship information between source data and new data, which is used for new data restored back to source data. If it occupies too much physical space (comparing with that of source data), then it will conflict with main purpose of users adopting cloud storage service—reduce local data storage occupancy.

As stated in the above, in content sequencing reorganization method, this space can be ignored. However for random reorganization method, the occupied physical space requirement is analyzed as follows,

For each new data restored back to source data, the correspondence relationship information between source data and new data needs to be saved mainly is,

sdᵢ=(Rxt₁₁ⁱ(s₁₁,e₁₁),Rxt₁₂ⁱ(s₁₂,e₁₂), . . . , Rxtᵣᵤⁱ(sᵣᵤ,eᵣᵤ))

If the source data and the reorganized new data are both 1 MB, which is to say, the source data and new data are of the same length, then it can be calculated out that the requirement for physical space of the cursors in each new data (namely s_{kq} or e_{kq}, here s_{kq} is the starting cursor position of the acquired data in tdₖ, e_{kq} is the ending cursor position of the acquired data in tdₖ) is no more than 3 B, so in the above correspondence relationship, the physical space of the starting and ending cursors of each corresponding data in tdₖ is not more than 6 B.

Further, assuming each source data corresponds to 30 new data (in order to ensure data security, set p=r=30), data acquisition times u=30, then it can be estimated that the physical space of the information of the correspondence relationship between each source data and new data is about 5400 B (6 B*30*30), which is about 1/200 of the space of the source data.

From the above analysis, for content reorganization method presented in this invention, it has demonstrated the requirement for local physical space to occupy is acceptable.

It can be concluded that, through the analysis on the feasibility and effectiveness of the above 2 methods of data content reorganization, the data security of the saved data is largely enhanced through content reorganization, which can mitigate the risk from user data illegal leak and decryption; in addition, the storage space of the data recovery information is relatively small comparing to that of the source data, which meet the design purpose of this invention.

In the embodiment of this invention, before transmitted to the cloud storage data center, the reorganized new data can also be de-duplicated and encrypted to further strengthen data security.

Accordingly, after data retrieved, it is also necessary to decrypt and restore the retrieved data.

As shown in FIG. 4, in accordance with an embodiment of this invention, a cloud storage data retrieval method comprises the following steps.

Step S401, retrieving the access data from cloud storage data center based on external access request;

Step S402, acquiring the data recovery information corresponding to the access data; and

Step S403, restoring the accessed data into source data according to the data recovery information.

Data recovery information is the information of the correspondence relationship between source data and new data saved at the time of content reorganization of the source data.

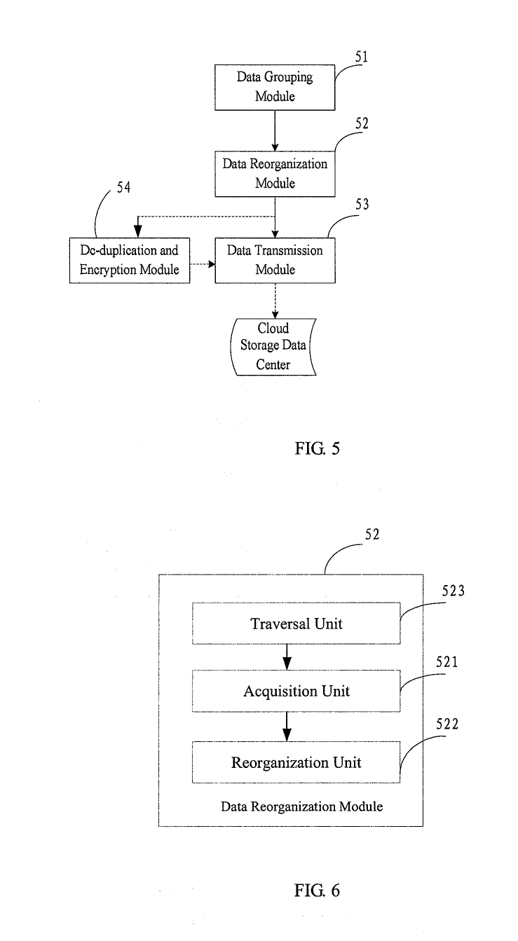

FIG. 5 illustrates a cloud storage data store apparatus in accordance with an embodiment of this invention. For the convenience of description, only the part relevant to this embodiment is provided here. This apparatus comprises:

data grouping module 51, data reorganization module 52 and data transmission module 53.

Before the source data store, data grouping module 51 will group the source data to be stored according to the predetermined grouping policy, data reorganization module 52 will reorganize the content of the source data grouped by the data grouping module 51 to form new data; after the reorganization is complete, the data transmission module 53 will transmit the new data formed by the data reorganization module 52 to the cloud storage data centers for storage.

As shown in FIG. 5, the cloud storage data store apparatus provided by the embodiment of this invention also includes de-duplication and encryption module 54. After the data reorganization module 52 reorganizes the content of the grouped source data to form new data, the de-duplication and encryption module 54 will de-duplicate and encrypt the new data reorganized by the data reorganization module 52, and after that the data transmission module 53 will transmit the data de-duplicated and encrypted by the de-duplication and encryption module 54 to the cloud storage data center for storage.

Further, data reorganization module 52 comprises:

an acquisition unit for acquiring data at the same location across each data group according to the predetermined fixed sequencing rules; and

a reorganization unit for reorganizing the data acquired by the acquisition unit in sequence to form new data.

Or, as shown in FIG. 6, data reorganization module 52 comprises

traversal unit 523 for traversing the source data which is to form new data according to the predetermined data reorganization rules;

acquisition unit 521 for acquiring data from source data according to the predetermined data acquisition rules; and

reorganization unit 522 for combining the data acquired by acquisition unit in sequence to form new data.

Further, data reorganization module 52 also comprises an output saving unit for outputting and saving the data recovery information of the correspondence relationship between source data and new data.

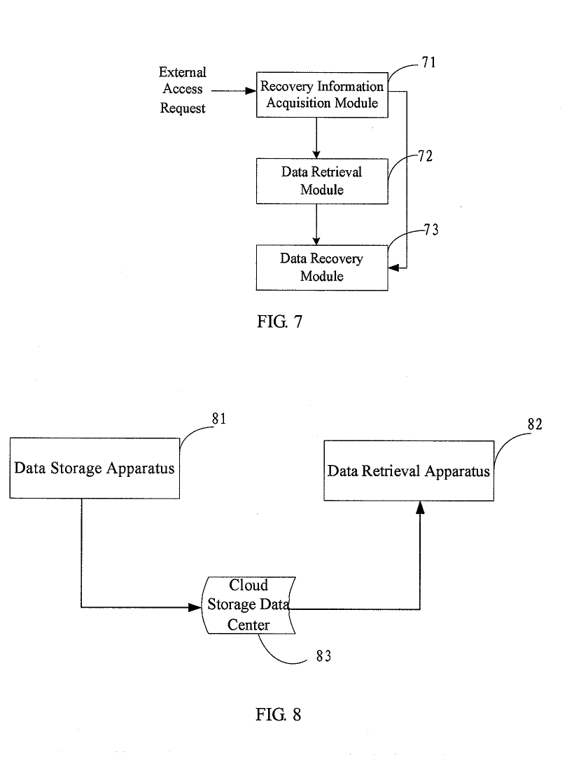

FIG. 7 shows a cloud storage data retrieval apparatus in accordance with an embodiment of this invention. For the convenience of description, we only provide the part relevant to this embodiment here. The apparatus comprises:

recovery information acquisition module 71, data retrieval module 72 and data recovery module 73.

When there is external data access request, the recovery information acquisition module 71 will acquire the data recovery information of the access data based on the access request, the data retrieval module 72 will retrieve the access data from the cloud storage data center according to the data recovery information acquired by the recovery information acquisition module 71, the data recovery module 73 will restore the accessed data retrieved by the data retrieval module to source data according to the data recovery module acquired by the recovery information acquisition module 71.

The data recovery module 73 comprises:

a decryption unit for decrypting the accessed data retrieved by the data retrieval module; and

a recovery unit for restoring the decrypted access data into source data according to the data recovery information acquired by the said recovery information acquisition module.

When the access data retrieved from the cloud storage data center by the data retrieval module 72 according to the data recovery information acquired by recovery information acquisition module 71 is de-duplicated and encrypted by de-duplication and encryption module 54, the decryption unit will decrypt the accessed data, and then the recovery unit will restore the decrypted data into source data.

As shown in FIG. 8, a cloud storage data storage and retrieval system in accordance with an embodiment of this invention comprises data storage apparatus 81, data retrieval apparatus 82 and cloud storage data center 83.

The data storage apparatus comprises:

a data grouping module for grouping the source data to be stored according to a predetermined grouping rule; a data reorganization module for reorganizing the source data grouped by the data grouping module in groups to form new data; and

a data transmission module for transmitting the,new data formed by the data reorganization module to a cloud storage data center for storage.

The data retrieval apparatus comprises:

a recovery information acquisition module for acquiring the data recovery information of the data to be accessed according to a access request;

a data retrieval module for retrieving the accessed data from a cloud storage data center according to the data recovery information acquired by the recovery information acquisition module; and

a data recovery module for restoring the access data retrieved by data retrieval module according to the data recovery information acquired by the recovery information acquisition module.

This invention largely improves data security of cloud storage, greatly mitigates the risk from user data illegal leak and decryption, and also meets the requirement on local physical storage occupancy for cloud storage service adoption, by grouping the source data to be stored according to the predetermined policies and transmitting the new data formed after the contents reorganization of the grouped source data in groups to cloud storage data centers, and saving the data recovery information of the correspondence relationship between source data and new data, while retrieving data acquiring the saved data recovery information, and according to the data recovery information, restore the retrieved data to source data.

The above embodiments have elaborated the objective, technical scheme and effect of this invention. It should be understood that the above embodiments are only,provided to illustrate this invention, and should not be used to limit this invention. Any modification, identical replacement and improvement, etc., based on the spirit and principles of this invention, shall be included in the protection scope of this invention.

1-15. (canceled)

16. A cloud storage data storing and retrieving method comprising:
grouping source data to be stored according to a predetermined grouping rule;
reorganizing content of the grouped source data to form new data; and
transmitting the new data to a cloud storage data center for storage.

17. The method of claim 16 wherein the step of reorganizing comprises:
acquiring data at the same location across each data group according to a predetermined fixed data sequencing rule; and
combining the acquired data in sequence to form new data.

18. The method of claim 16 wherein the step of reorganizing comprises:
traversing the grouped source data;
acquiring data randomly from the source data according to a predetermined data acquisition rule; and
combining the acquired data in sequence to form new data.

19. The method of claim 16 wherein the step of reorganizing comprises outputting and saving data recovery information of corresponding relationship between the source data and new data.

20. The method of claim 16 further comprising a step of de-duplicating and encrypting the new data prior to the transmitting step.

21. The method of claim 16 further comprising:
retrieving data from the cloud storage data center according to a data access request;
retrieving data recovery information corresponding to the accessed data; and
restoring the accessed data to source data according to the data recovery information.

22. The method of claim 21 wherein the step of restoring comprises:
decrypting the accessed data; and
restoring the decrypted accessed data to source data according to the data recovery information.

23. A cloud storage data storage apparatus comprising
a data grouping module for grouping source data to be stored according to a predetermined grouping rule;
a data reorganization module for reorganizing the content of the source data grouped by the data grouping module to form new data; and
a data transmission module for transmitting the new data formed by the data reorganization module to a cloud storage data center for storage.

24. The apparatus of claim 23 wherein the data reorganization module comprises:
an acquisition unit for acquiring data from the same location across each data group according to a predetermined fixed data sequencing rule; and
a reorganization unit for reorganizing the data acquired by the acquisition unit in sequence to form new data.

25. The apparatus of claim 23 wherein the data reorganization module comprises:
a traversal unit for traversing the source data;
an acquisition unit for acquiring data from the source data according to a predetermined fixed data sequencing rule; and
a reorganization unit for reorganizing the data acquired by the acquisition unit in sequence to form new data.

26. The apparatus of claim 23 wherein the data reorganization module comprises an output and save unit for outputting and saving the data recovery information corresponding to the relationship between the source data and new data.

27. The apparatus of claim 23 further comprising a de-duplication and encryption module for de-duplicating and encrypting the new data formed by the data reorganization module.

28. A cloud storage data storage and retrieval system comprising a data storage apparatus, a data retrieval apparatus, and a cloud storage data center;
the data storage apparatus comprises:
a data grouping module for grouping source data to be stored according to a predetermined grouping rule;
a data reorganization module for reorganizing the content of the source data grouped by the data grouping module to form new data; and
a data transmission module for transmitting the new data formed by the data reorganization module to a cloud storage data center for storage.
the data retrieval apparatus comprises:
a recovery information acquisition module for acquiring the data recovery information of the accessed data according to access request;
a data retrieval module for retrieving the accessed data from a cloud storage data center according to the data recovery information acquired by the recovery information acquisition module; and
a data recovery module for restoring the accessed data retrieved by the said data retrieval module according to the data recovery information acquired by the recovery information acquisition module.

29. The apparatus of claim 28 wherein the data recovery module comprises:
a decryption unit for decrypting the access data retrieved by the data retrieval module; and
a recovery unit for restoring the decrypted access data to source data according to the data recovery information acquired by the said recovery information acquisition module.
